(19) United States
(12) Patent Application Publication
(10) Pub. No.: US 2022/0357547 A1
(43) Pub. Date: Nov. 10, 2022

(54) LENS ASSEMBLY DEVICE

(71) Applicant: SAMSUNG ELECTRO-MECHANICS CO., LTD., Suwon-si (KR)

(72) Inventors: Young Suk KANG, Suwon-si (KR); Do Hyeong JANG, Suwon-si (KR); Yong Joo JO, Suwon-si (KR)

(73) Assignee: SAMSUNG ELECTRO-MECHANICS CO., LTD., Suwon-si (KR)

(21) Appl. No.: 17/694,985

(22) Filed: Mar. 15, 2022

(30) Foreign Application Priority Data
May 4, 2021 (KR) 10-2021-0058066
Oct. 29, 2021 (KR) 10-2021-0147266

(51) Int. Cl. G02B 7/02; G02B 27/64; G03B 5/02; G03B 13/34

(52) U.S. Cl. CPC G02B 7/021; G02B 27/646; G03B 5/02; G03B 13/34; G03B 2205/0007

(57) ABSTRACT

A provided lens assembly device includes a lens assembly that has a plurality of adjacently lens modules, each accommodating one or more lenses, and a lens holder where the plurality of lens modules are disposed, where, for each of the plurality of lens modules, a respective lens module includes a side surface facing another lens module, of the plurality of lens modules, disposed adjacent to the respective lens module, where the side surface includes at least a first flat surface, and at least one lens, of the one or more lenses of the respective lens module, having a first total length in a first axial direction, perpendicular to an optical axis of the respective lens module, and a second total length in a second axial direction, perpendicular to both the optical axis and the first axial direction, where the first total length is longer than the second total length.

### CROSS-REFERENCE TO RELATED APPLICATION(S)

This application claims benefit of priority to Korean Patent Application No. 10-2021-0058066 filed on May 4, 2021 and Korean Patent Application No. 10-2021-0147266 filed on Oct. 29, 2021 in the Korean Intellectual Property Office, the entire disclosures of which are incorporated herein by reference for all purposes.

### BACKGROUND

### 1. Field

The present disclosure relates to a lens assembly device.

### 2. Description Of Related Art

Camera modules have been used in electronic devices. As a non-limiting example, camera modules have been used in portable electronic devices such as smart phones, tablet PCs, and notebook computers.

In addition, in recent years, the number of pixels of an image sensor and the size of the image sensor itself have increased, e.g., in order to capture a high-resolution image or video, and the number of lenses has also increased. Such increased numbers of lenses, or increased numbers of lenses and increased image sensor sizes, have resulted in corresponding

camera modules having also increased in size. However, due to the increased size of the camera modules, the camera module may protrude from the portable electronic device, which may be problematic.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a lens assembly device includes a lens assembly having a plurality of lens modules arranged adjacently to each other, where each of the plurality of lens modules respectively accommodates one or more lenses, and a lens holder in which the plurality of lens modules are disposed, where, for each of the plurality of lens modules, a respective lens module includes a side surface facing another lens module, of the plurality of lens modules, that is disposed adjacent to the respective lens module, where the side surface includes at least a first flat surface, and at least one lens, of the one or more lenses of the respective lens module, having a first total length in a first axial direction, perpendicular to an optical axis of the respective lens module, and a second total length in a second axial direction, perpendicular to both the optical axis and the first axial direction, where the first total length is longer than the second total length.

The respective lens module of each of the plurality of lens modules may further include an opening penetrating through the first flat surface, and a portion of the at least one lens being exposed to an exterior of the respective lens module through the opening.

The respective lens module of each of the plurality of lens modules may further include a first side surface portion, a second side surface portion, a third side surface portion, and a fourth side surface portion, the first side surface portion and the second side surface portion being disposed to face each other with respect to the optical axis, the third side surface portion and the fourth side surface portion being disposed to face each other with respect to the optical axis, and a total distance between the first side surface portion and the second side surface portion being larger than a total distance between the third side surface portion and the fourth side surface portion.

The respective lens module of each of the plurality of lens modules may further include the first flat surface being provided at the third side surface portion or the fourth side surface portion to face the other lens module, and the first flat surface having an opening penetrating through the first flat surface, from an interior of the respective lens module to an exterior of the respective lens module.

The respective lens module of each of the plurality of lens modules may further include the first flat surface being provided at the third side surface portion or the fourth side surface portion to face the other lens module, the second side surface portion or the first side surface portion being disposed to face an additional lens module, of the plurality of lens modules, that is disposed adjacent to the respective lens module, and the first side surface portion and the second side surface portion each have a second flat surface.

The respective lens module of each of the plurality of lens modules may further include the first flat surface having a first opening penetrating through the first flat surface in the second axial direction, from an interior of the respective lens module to an exterior of the respective lens module, and the second flat surface of the first side surface portion or the second side surface portion having a second opening penetrating through the second flat surface in the first axial direction, from the interior of the respective lens module to the exterior of the respective lens module.

The plurality of lens modules may include at least a first lens module, a second lens module, a third lens module, and a fourth lens module, each further including a first surface portion and a second surface portion, where an opening in the first flat surface of the first lens module may face an opening in the first flat surface of the second lens module to expose a side surface of the at least one lens of the first lens module to a side surface of the at least one lens of the second lens module, and an opening through the first flat surface of the third lens module may face an opening in the first flat surface of the fourth lens module to expose a side surface of the at least one lens of the third lens module to a side surface of the at least one lens of the fourth lens module, where the first surface portion of the first lens module may face the second surface portion of the third lens module, and the second surface portion of the second lens module may face the first surface portion of the fourth lens module, and where the second surface portion of the first lens module may include a first opening, the first surface portion of the second lens module may include a second opening, the first surface portion of the third lens module may include a third opening, and the second surface portion of the fourth lens module may include a fourth opening, where each of the first opening, the second opening, the third opening, and the fourth opening may respectively expose another side surface of the at least one lens of each of the first lens module, the second lens module, the third lens module, and the fourth lens module to respective exteriors of the first lens module, the second lens module, the third lens module, and the fourth lens module.

The respective lens module of each of the plurality of lens modules may further include the at least one lens having an optical portion and flange portions extending from the optical portion, and the optical portion having a first edge, a second edge, a third edge, and a fourth edge when viewed in an optical axis direction of the respective lens module, with the first edge having an arc shape, the second edge being provided on an opposite side from the first edge with respect to the optical axis and having an arc shape, and the third edge and the fourth edge respectively connecting the first edge and the second edge to each other.

The respective lens module of each of the plurality of lens modules may further include an opening in the first flat surface through which the third edge or the fourth edge is exposed to an exterior of the respective lens module, to expose the optical portion to the exterior, and the opening of a first lens module of the plurality of lens modules may face the opening of a second lens module of the plurality of lens modules.

The respective lens module of each of the plurality of lens modules may further include the flange portions having a first flange portion extending from the first edge, and a second flange portion extending from the second edge.

The respective lens module of each of the plurality of lens modules may further include a side surface of the first flange portion having a first flat surface portion and first curved surface portions, a side surface of the second flange portion having a second flat surface portion and second curved surface portions, the first flat surface portion and the second flat surface portion being surfaces meeting a virtual line passing through the optical axis and extending in the first axial direction, the first curved surface portions being disposed on both sides of the first flat surface portion, and the second curved surface portions being disposed on both sides of the second flat surface portion.

The respective lens module of each of the plurality of lens modules may further include surfaces of the respective lens module, which correspond to the first flat surface portion and the second flat surface portion, having openings through which the first flat surface portion and the second flat surface portion are at least partially exposed to the exterior of the respective lens module, respectively.

The lens holder may have opening portions through which portions of respective side surfaces of each of the plurality of lens modules are exposed, and the opening portions may be respectively provided at positions, along an exterior of the lens holder, that meet respective virtual lines connecting optical axes of lens modules, of the plurality of lens modules, disposed to face each other in respective diagonal directions.

The device may further include single image sensor, wherein the lens assembly and single image sensor are configured as a camera module.

A shorter side of a virtual rectangle, connecting each optical axis of the plurality of lens modules, may be parallel to a shorter side of the single image sensor, and a longer side of the virtual rectangle may be parallel to a longer side of the single image sensor.

In one general aspect, a lens assembly device includes a camera module that includes a plurality of lens modules arranged adjacently to each other, where each of the plurality of lens modules respectively accommodates one or more lenses, a lens holder accommodating the plurality of lens modules, a housing accommodating the lens holder, and an image sensor module coupled to the housing, where, for each of the plurality of lens modules, a respective lens module includes four side surfaces, each of the four side surfaces having at least a flat surface, at least one side surface of the four side surfaces having an opening penetrating through the flat surface of the at least one side surface, at least one lens, of the one or more lenses of the respective lens module, having a first total length in a first axial direction, perpendicular to an optical axis of the respective lens module, and a second total length in a second axial direction, perpendicular to both the optical axis and the first axial direction, where the first total length is longer than the second total length, and at least a portion of a side surface of the at least one lens being exposed to an outside of the respective lens module through the opening.

The image sensor module may include a single image sensor configured in the camera module for receipt of light directed by each of the plurality of lens modules toward the single image sensor.

A shorter side of a virtual rectangle, connecting each optical axis of the plurality of lens modules, may be parallel to a shorter side of the single image sensor, and a longer side of the virtual rectangle may be parallel to a longer side of the single image sensor.

An area of a virtual rectangle, connecting each optical axis of the plurality of lens modules, to each other may be smaller than an area of an effective image capturing region of the single image sensor.

With respect to capturing an image of an entirety of an object, each of the one or more lenses of the plurality of lens modules may respectively direct light from at least differently observed portions of the object toward at least separate portions of the single image sensor, or each of the one or more lenses of the plurality of lens modules may respectively direct light of the entirety of the object toward at least same portions of the single image sensor.

In one general aspect, a lens assembly device includes a camera module that includes a single image sensor, a plurality of lens modules arranged adjacently to each other, where each of the plurality of lens modules respectively accommodates one or more lenses, and a lens holder accommodating the plurality of lens modules, where the plurality of lens modules include two lens modules each having abutting side surfaces meeting a virtual line passing through optical axes of the two lens modules, with the abutting side surfaces having adjacent openings that expose respective side surfaces of optical portions of lenses, respectively of the one or more lenses, of the two lens modules to each other, and where each of the lenses further include respective flanges that extend from the optical portions, where the respective flanges are disposed to face at least respective interior side surfaces of the two lens modules.

For each of the lenses, a respective lens may include a first total length in a first axial direction, perpendicular to an optical axis of the respective lens, and a second total length in a second axial direction, perpendicular to the optical axis and the first axial direction, where the first total length is longer than the second total length.

The respective interior side surfaces may each have a surface portion with an opening that exposes respective side surfaces of the flanges to respective exteriors of the two lens modules.

The plurality of lens modules may include another two lens modules each having other abutting side surfaces meeting a virtual line passing through optical axes of the other two lens modules, with the other abutting side surfaces having adjacent openings that expose respective side surfaces of optical portions of other lenses, respectively of the one or more lenses, of the other two lens modules to each other.

The plurality of lens modules may include only four lens modules.

Each of the optical portions and the other optical portions may have a first edge, a second edge, and a third edge when viewed in an optical axis direction of a corresponding lens module, with the first edge having an arc shape, the second edge being provided on an opposite side from the first edge with respect to the optical axis of the corresponding lens module and having an arc shape, and the third edge connecting the first edge and the second edge to each other, where the exposure of the side surfaces of the respective edges of the optical portions of the lenses of the two lens modules to each other ma include exposing the third edge of each of the two lens modules to each other, and the exposure of the side surfaces of the respective edges of the optical portions of the other lenses of the other two lens modules to each other may include exposing the third edge of each of the other two lens modules to each other.

A shorter side of a virtual rectangle, connecting each optical axis of the plurality of lens modules, may be parallel to a shorter side of the single image sensor, and a longer side of the virtual rectangle may be parallel to a longer side of the single image sensor.

The lens holder may have opening portions through which portions of respective side surfaces of each of the plurality of lens modules are exposed, and the opening portions may be respectively provided at positions, along an exterior of the lens holder, that meet respective virtual lines connecting optical axes of lens modules, of the plurality of lens modules, that are disposed to face each other in respective diagonal directions.

The plurality of lens modules and the lens holder are included in a lens assembly, and wherein the camera module is configured to move the lens assembly in a direction parallel to the optical axes and relative to the single image sensor and/or move the lens assembly in one or more directions perpendicular to the optical axes and relative to the single image sensor, for respectively performing focus adjustments and/or image stabilization.

Other features and aspects will be apparent from the following detailed description, the drawings, and the claims.

### BRIEF DESCRIPTION OF DRAWINGS

FIG. 1 is a perspective view of a camera module, according to one or more embodiments.

FIG. 2 is a schematic exploded perspective view of a camera module, according to one or more embodiments.

FIGS. 3 and 4 are reference views illustrating an image capturing screen of a camera module, according to one or more respective embodiments.

FIG. 5 is a plan view of a lens assembly, according to one or more embodiments.

FIG. 6 is a schematic exploded perspective view of a lens assembly, according to one or more embodiments.

FIGS. 7A through 7C are perspective views illustrating a lens module included in a lens assembly from various angles, according to one or more embodiments.

FIG. 8 is a plan view of a lens having a non-circular planar shape, according to one or more embodiments.

FIG. 9 is a perspective view of first to fourth lens modules, according to one or more embodiments.

FIG. 10 is a schematic view illustrating alignment of a lens assembly and an image sensor, according to one or more embodiments.

Throughout the drawings and the detailed description, unless otherwise described or provided, the same drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

For explanatory purposes, some elements, components, or features may be omitted from discussion in some embodiments, but the omission of such elements, components, or features is not intended to mean that such embodiments may not include any or all of such elements, components, of features. Likewise, for such explanatory purposes, and as a non-limiting example, a thickness, for example, of such elements, component, or features may be illustrated with an enlarged or expanded form or shape to focus an explanation on various layers and regions, but embodiments are not limited thereto. For example, as noted above, the drawings may not be to scale, and the relative size, proportions, and depiction of elements in the drawings may be exaggerated for clarity, illustration, and convenience. In addition, components having a same or like function within a scope of a same or like idea may also be referred to as the same, though embodiments are not limited thereto.

The articles “a,” “an,” and “the” are intended to include the plural forms as well, unless the context clearly indicates otherwise. In addition, the terminology used herein is for describing various examples, and is not to be used to limit the disclosure. The expressions “has”/“have” or “may have”, “includes” or “may include”, “comprises” or “may comprise,” and the like, may specify the presence of stated features, numbers, operations, members, elements, and/or combinations thereof in various embodiments, but do not preclude the presence or addition of one or more other features, numbers, operations, members, elements, and/or combinations thereof in other various embodiments. In addition, herein, it is further noted that such a use of the term ‘may’ with respect to an example or embodiment, e.g., as to what an example or embodiment may include or implement, means that at least one example or embodiment exists where such a feature is included or implemented while all examples and embodiments are not limited thereto. Likewise, such expressions that indicate that a corresponding characteristic (e.g., a numerical value, function, operation, or component such as a part) may exist or may be present with respect to such stated features, numbers, operations, members, elements, and/or combinations thereof, does not exclude the presence of additional or alternate such corresponding characteristics, while again noting that the use of the term ‘may’ also means that embodiments are not limited to the existence or presence of a corresponding characteristic unless the disclosure makes clear otherwise.

In this specification, expressions such as “A and/or B”, “at least one of A and B”, or “one or more of A and B” may include all possible combinations of the items listed together. For example, “A and/or B”, “at least one of A and B”, or “one or more of A and B” means (1) including at least one A; (2) including at least one B, or (3) including both of at least one A and at least one B.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

In the drawings, an X direction may be defined as a first direction, an L direction, or a length direction. AY direction may be defined as a second direction, a W direction, or a width direction. A Z direction may be defined as a third direction, a T direction, a thickness direction, or an optical axis direction. Additionally, other spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

Unless otherwise defined, all terms, including technical and scientific terms, used herein have the same meaning as commonly understood by one of ordinary skill in the art to which this disclosure pertains after an understanding of the disclosure of this application. Terms, such as those defined in commonly used dictionaries, are to be interpreted as having a meaning that is consistent with their meaning in the context of the relevant art and the disclosure of the present application, and are not to be interpreted in an idealized or overly formal sense unless expressly so defined herein.

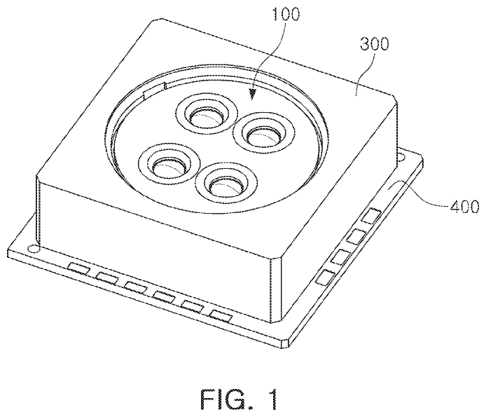

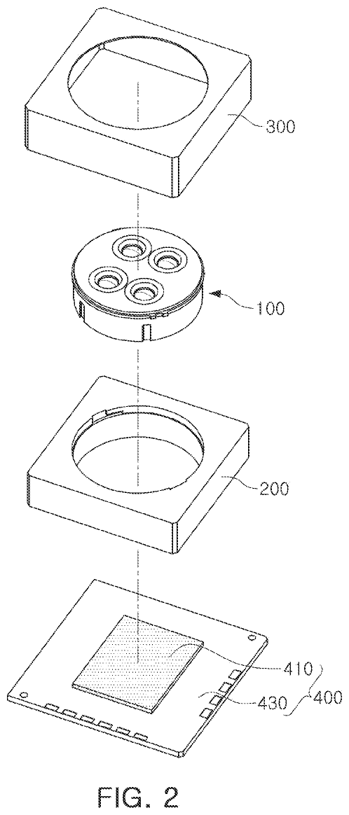

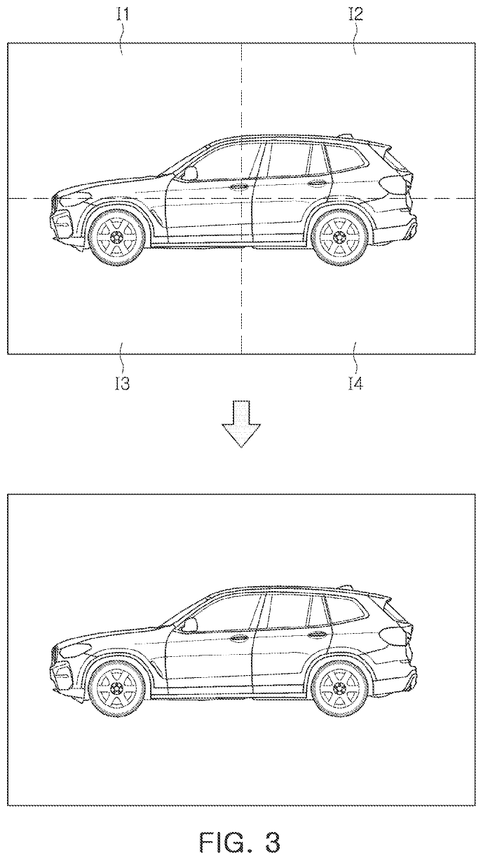

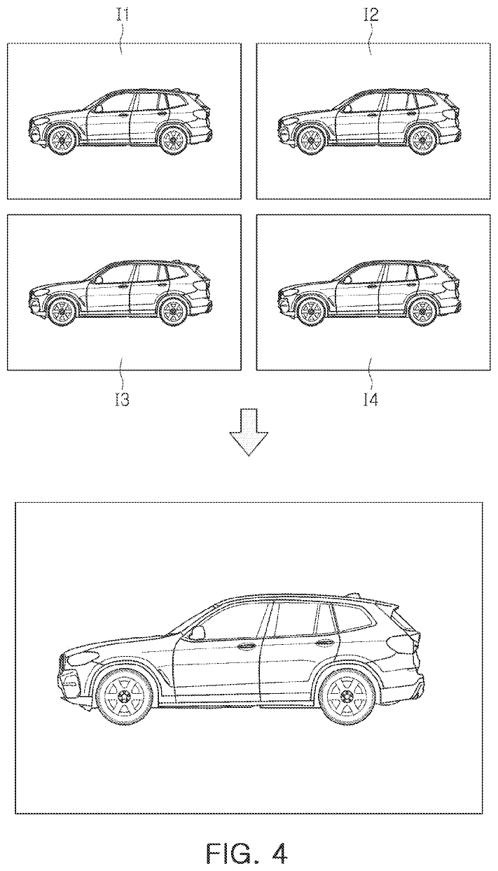

FIG. 1 is a perspective view of a camera module, according to one or more embodiments, FIG. 2 is a schematic exploded perspective view of a camera module, according to one or more embodiments, and FIGS. 3 and 4 are reference views illustrating an image capturing screen of a camera module, according to one or more respective embodiments. The camera module may also be referred to as a lens assembly device.

The example embodiments may include, or be applied to, electronic devices, e.g., portable electronic devices such as mobile communication terminals, smart phones, and tablet PCs, as non-limiting examples. An electronic device may also be referred to as a lens assembly device.

First, referring to FIGS. 1 and 2, a camera module, according to one or more example embodiments, may include a lens assembly 100, a housing 200, a case 300, and an image sensor module 400, for example.

The lens assembly 100 may include a plurality of lens modules. The plurality of lens modules may each have respective optical axes. The optical axes of adjacent lens modules may be arranged in parallel, for example.

The plurality of lens modules may be arranged in an n x n matrix structure, or may be arranged in an n×m matrix structure. Here, n and m are respectively a different natural number of 2 or more.

Hereinafter, an embodiment in which the plurality of lens modules are arranged in a 2×2 matrix structure will be described for convenience of explanation, while noting that alternative embodiments also exist. For example, the plurality of lens modules may include a first lens module 110, a second lens module 130, a third lens module 150, and a fourth lens module 170.

As non-limiting examples, a deviation of focal lengths of the plurality of lens modules may be within ±0.03 mm, a deviation of angles of view may be within ±3°, and a deviation of distortions may be within ±3°.

The lens assembly 100 may be accommodated in the housing 200. The camera module may be configured to perform focus adjustments and/or image stabilization.

For example, the lens assembly 100 may be controlled to move in an optical axis direction with respect to the housing 200 to perform focusing. In addition, the lens assembly 100 may be controlled to move in a direction, e.g., perpendicular to the optical axis with respect to the housing 200, to perform image stabilization. Here, the optical axis direction with respect to the housing 200 may be a vertical direction in FIGS. 1 and 2, e.g., where an example width direction and length direction of the housing 200 may each represent respective directions perpendicular to the optical axis direction.

For example, camera module in an embodiment may include one or more actuators respectively configured to move the lens assembly 100 in the optical axis direction and/or one or more directions perpendicular to the optical axis direction, e.g., to respectively perform the focus adjustments and/or the image stabilization.

The case 300 may be coupled to the housing 200 with the lens assembly 100, and may protect an internal configuration of the camera module.

In an embodiment, the camera module may include an image sensor module 400, which may be coupled to the housing 200, for example. As a non-limiting example, the image sensor module 400 may include an image sensor 410 and a printed circuit board 430 to which the image sensor 410 is connected. Here, the image sensor 410 may be provided as one image sensor 410, for example, in receipt of light from each of a plurality of lens modules.

That is, in an embodiment, the lens assembly 100 may include a plurality of lens modules, where an example image sensor module 400 may not be representative of a plurality of image sensors corresponding to the respective lens modules, but rather, may be a single image sensor 410 receiving light passing through each lens module, e.g., of the four lens modules. For example, image sensor 410 may be respectively configured to receive light directed by each of the plurality of lens modules toward the image sensor 410.

Positions in which rays of light passing through the lens modules are respectively received by the single image sensor 410 may be different from each other. For example, a position in which the light passing through the first lens module 110 is received, a position in which the light passing through the second lens module 130 is received, a position in which the light passing through the third lens module 150 is received, and the position in which the light passing through the fourth lens module 170 is received may be different from each other.

Referring to FIGS. 3 and 4, a camera module according to one or more examples may generate one complete image by combining images captured by a plurality of lens modules.

Referring to FIG. 3, an image capturing target may be divided into sections, where each lens module may be configured to capture a respective image of a corresponding divided section of the image capturing target, and thus, these captured images may be combined to thereby generate one complete image at the single image sensor.

For example, the first lens module 110 may capture a first image I1 corresponding to a first region of the image capturing target, the second lens module 130 may capture a second image I2 corresponding to a second region of the image capturing target, the third lens module 150 may capture a third image I3 corresponding to a third region of the image capturing target, and the fourth lens module 170 may capture a fourth image I4 corresponding to a fourth region of the image capturing target.

Then, the first to fourth images I1 to I4 may become combined at a single image sensor to generate one complete image representing the image capturing target.

Since one lens module may not capture an image of the entire image capturing target, a size of the lens module may be smaller than that in a case in which one lens module would be used to capture an image of the same entire image capturing target. Further, according to an embodiment, the number of lenses included in each lens module of the camera module may be less than that in the case in which the one lens module would project light to an entirety of an image sensor, e.g., an image sensor having a size alike the size of the image sensor 410.

Accordingly, the camera module according to an embodiment may divide the image capturing target, capture a respective image of a corresponding divided section of the image captured target, and combine these captured images to generate one complete image at a single image sensor, e.g., such that the camera module may have a small size even while using the image sensor 410 having a large number of pixels and a large size.

Referring to FIG. 4, the plurality of lens modules may each capture an image of an entirety, for example, of a same image capturing target, and these captured images may be combined to thereby generate one complete image at a single image sensor.

For example, the first to fourth lens modules 110 to 170 may capture images of the same image capturing target to generate the first to fourth images I1 to I4, respectively.

Then, the first to fourth images I1 to I4 may be combined at the single image sensor to generate one image having a higher resolution than the individual images. For example, each of the lens modules may generate an image with a first resolution, resulting in the generated one image having a different resolution that is higher than the first resolution.

Accordingly, the camera module according to an embodiment may combine images captured by multiple lens modules, such that the camera module may have a small size even while using the image sensor 410 having a large number of pixels and a large size.

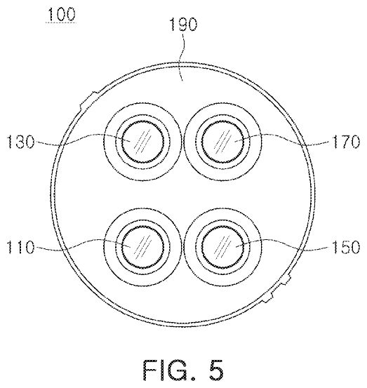

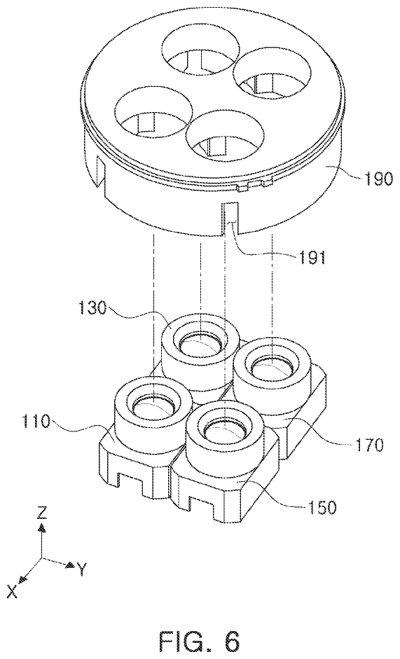

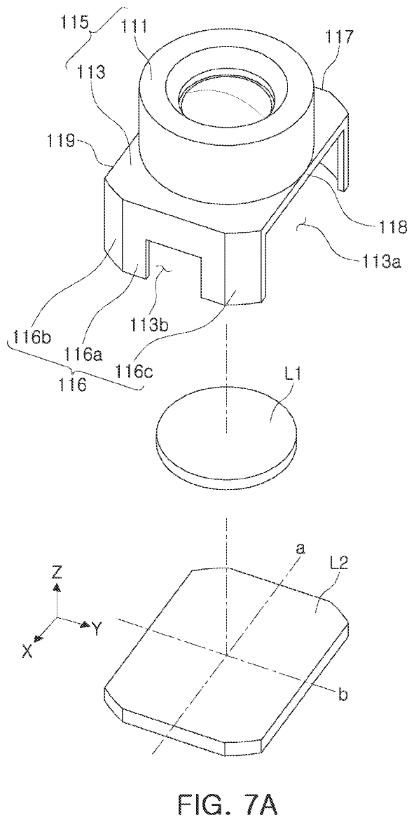

FIG. 5 is a plan view of a lens assembly according to one or more embodiments, FIG. 6 is a schematic exploded perspective view of a lens assembly according to one or more embodiments, and FIGS. 7A through 7C are perspective views illustrating a lens module included in a lens assembly from various angles, according to one or more embodiments. In an example, the lens assembly and lens module are respectively the same lens assembly and lens module. The lens assembly may also be referred to as a lens assembly device.

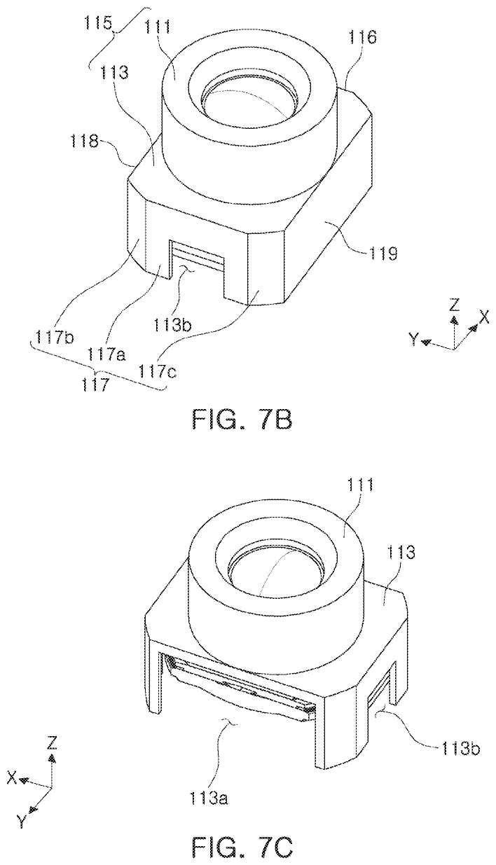

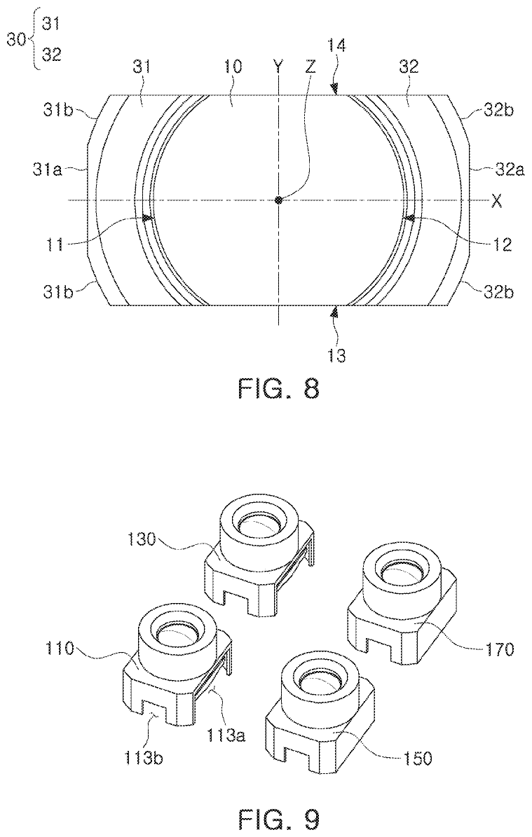

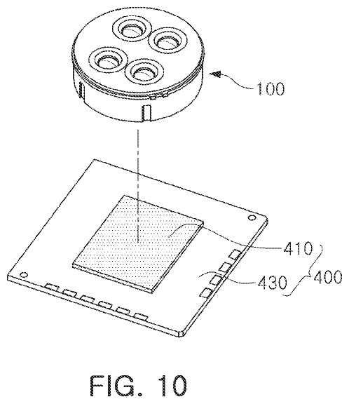

FIG. 8 is a plan view of a lens having a non-circular planar shape, according to one or more embodiments, FIG. 9 is a perspective view of example first to fourth lens modules, according to one or more embodiments, and FIG. 10 is a schematic view illustrating alignment of a lens assembly and an image sensor, according to one or more embodiments. In an example, the first to fourth lens modules may each include a lens such as shown in FIG. 8, and the first to fourth lens modules may be included in the lens assembly.

First, referring to FIGS. 5 and 6, the lens assembly 100 according to an example embodiment in the present disclosure may include the first lens module 110, the second lens module 130, the third lens module 150, and the fourth lens module 170, and may further include a lens holder 190.

Each lens module may include one or more lenses and a lens barrel, where each of the one or more lenses may be respectively disposed inside a corresponding lens barrel of each lens module. In a case in which a plurality of lenses are provided in one or more of the lens modules, the plurality of lenses may be mounted inside the corresponding lens barrel along the optical axis.

The first to fourth lens modules 110 to 170 may be fixedly disposed inside the lens holder 190.

In one case, an array lens in which a plurality of lenses are arranged in a matrix pattern on a single plate is used in order to generate one complete image by dividing the image capturing target, capturing an image of each section of the divided image capturing target, and combining the captured images, or by combining multiple images of the same image capturing target.

In this case, multiple array lenses may be stacked in the optical axis direction, thereby implementing a lens assembly having a plurality of optical axes. Further, each of the array lenses having the plurality of optical axes is arranged in one lens barrel.

However, when multiple array lenses are stacked in one lens barrel, the respective optical axes of each lens of one array lens may not be aligned with the respective optical axes of each lens of another array lens stacked in the one lens barrel, e.g., as the respective multiple optical axes of each array lens may not be individually aligned, which is seriously problematic.

However, in a lens assembly 100 according to one or more embodiments, the plurality of lens modules may be individually or separately arranged in the lens holder 190, e.g., in respective lens barrels, such that the optical axes of each of the plurality of lens modules may be individually aligned in one or more embodiments.

For example, opening portions 191 may be provided in the lens holder 190, and may each penetrate through a side surface of the lens holder 190 in a diagonal direction with respect to the optical axis.

In an example, a virtual line connecting the optical axis of the first lens module 110 and the optical axis of the fourth lens module 170 may also connect to an opening portion 191 closest to the first lens module 110 and an opening portion 191 closest to the fourth lens module 170, and a virtual line connecting the optical axis of the second lens module 130 and the optical axis of the third lens module 150 may also connect to an opening portion 191 closest to the second lens module 130 and an opening portion 191 closest to the third lens module 150, and the two virtual lines may cross each other.

Accordingly, a portion of a side surface of each of the first to fourth lens modules 110 to 170 may be exposed to the outside through a corresponding opening portion 191.

Since the plurality of lens modules may be arranged in an n×n or n×m matrix structure, the size of the lens assembly 100 in a diagonal direction of the arranged matrix structure may be the largest.

Since the lens holder 190 has the opening portions 191 penetrating through the side surface of the lens holder 190 in the diagonal direction with respect to the respective optical axes of the lens modules, the size of the lens assembly 100 may be reduced.

FIGS. 7A through 7C are perspective views of a first lens module 110. Hereinafter, the first lens module 110 will be described for convenience of explanation, but a second to fourth lens modules 130 to 170 of a lens assembly may also have the same or like shape as the first lens module 110. For example, first to fourth lens modules 110 to 170 of the lens assembly may be identical though orientated differently with respect to each other.

The first lens module 110 may include at least one lens and a first lens barrel 115.

The first lens barrel 115 may include a first barrel 111 and a second barrel 113. The first barrel 111 and the second barrel 113 may refer to an upper part and a lower part of one lens barrel, respectively. In one embodiment, the first barrel 111 and the second barrel 113 may be provided as separate components and coupled to each other, noting that embodiments are not limited thereto.

The first barrel 111 may have a cylindrical shape having an inner space, and the second barrel 113 may have a rectangular box shape having an inner space. An upper surface of the first barrel 111 and a lower surface of the second barrel 113 may have passage holes through which light passes, respectively.

At least one lens L1 (hereinafter, referred to as a “first lens”) having a circular planar shape may be disposed inside the first barrel 111, and at least one lens L2 (hereinafter, referred to as a “second lens”) having a non-circular planar shape may be disposed inside the second barrel 113.

For example, referring to FIG. 7A, the second lens L2 may be non-circular when viewed in the optical axis direction.

On a plane perpendicular to the optical axis, a length of the second lens L2 in a first axial direction, perpendicular to the optical axis may be longer than a length of the second lens L2 in a second axial direction, perpendicular to both the optical axis and the first axial direction. An optical axis of a lens of a lens module, e.g., in a lens assembly, may also be the optical axis of the lens module.

For example, the second lens L2 may have a major axis a and a minor axis b. A virtual line segment that connects both sides of the second lens L2 in the first axial direction while passing the optical axis may be the major axis a, and a virtual line segment that connects both sides of the second lens L2 in the second axial direction while passing the optical axis may be the minor axis b. The major axis a and the minor axis b may be perpendicular to each other, and a length of the major axis a may be longer than a length of the minor axis b.

The second lens L2 may have four side surfaces along a circumference of the second lens L2. When viewed in the optical axis direction, two of the four side surfaces may have a substantially linear shape, each of the other two side surfaces may have an arc-shape portion and a linear portion.

For example, the planar shape of the second lens L2 may be a rectangular shape with rounded corners, noting that other shapes are also available.

In an embodiment, in general, the image sensor 410 is rectangular. Therefore, not all images of light refracted by the circular lens are formed on the image sensor 410.

According to an embodiment, the second lens L2 has a non-circular planar shape. As a result, the lens and the lens barrel may have small sizes without affecting image formation, thereby reducing the sizes of the lens module and the camera module.

Meanwhile, the second lens L2 has the major axis a and the minor axis b, and thus has a maximum diameter and a minimum diameter. Here, the maximum diameter of the second lens L2 is larger than a diameter of the first lens L1.

That is, the second lens L2 having a relatively large diameter may have a non-circular planar shape.

The lens (for example, the second lens L2) having a non-circular planar shape will be described in greater detail with reference to FIG. 8.

The second lens L2 may have an optical portion 10 and flange portions 30.

The optical portion 10 may be a portion where optical performance of the second lens L2 is exhibited. For example, light reflected from a subject may be refracted when passing through the optical portion 10.

The optical portion 10 may have refractive power and may have an aspherical shape.

The flange portion 30 may fix the second lens L2 to another component, for example, the lens barrel or another lens.

The flange portion 30 may extend from the optical portion 10 and may be integrally formed with the optical portion 10.

The optical portion 10 may be formed in a non-circular shape. For example, the optical portion 10 may be non-circular when viewed in the optical axis direction. Referring to FIG. 8, in a plane perpendicular to the optical axis (Z-axis), a length of the optical portion 10 in the first axial direction (X-axis direction) perpendicular to the optical axis (Z-axis) may be longer than a length of the optical portion 10 in the second axial direction (Y-axis direction) perpendicular to both the optical axis (Z-axis) and the first axial direction (X-axis direction).

The optical portion 10 may have a first edge 11, a second edge 12, a third edge 13, and a fourth edge 14.

When viewed in the optical axis direction (Z-axis direction), the first edge 11 and the second edge 12 may each have an arc shape.

The second edge 12 may be provided on the opposite side from the first edge 11. In addition, the first edge 11 and the second edge 12 may be positioned to face each other based on the optical axis (Z-axis).

The fourth edge 14 may be provided on the opposite side from the third edge 13. In addition, the third edge 13 and the fourth edge 14 may be positioned to face each other based on the optical axis (Z-axis).

The third edge 13 and the fourth edge 14 may each connect the first edge 11 and the second edge 12. The third edge 13 and the fourth edge 14 may be symmetric with respect to the optical axis (Z-axis), and may be parallel to each other.

When viewed in the optical axis direction (Z-axis direction), the first edge 11 and the second edge 12 may have an arc shape, and the third edge 13 and the fourth edge 14 may generally have a substantially linear shape.

The optical portion 10 may have a major axis and a minor axis. A virtual line segment that connects the third edge 13 and the fourth edge 14 with the shortest distance while passing the optical axis (Z-axis) may be the minor axis, and a virtual line segment that connects the first edge 11 and the second edge 12 while passing the optical axis (Z-axis) and is perpendicular to the minor axis may be the major axis. A length of the major axis may be longer than a length of the minor axis.

The flange portion 30 may extend in the first axial direction (X-axis direction) along a partial circumference of the optical portion 10. At least a portion of the flange portion 30 may be in contact with an inner surface of the lens barrel.

The flange portions 30 may include a first flange portion 31 and a second flange portion 32. The first flange portion 31 may extend from the first edge 11 of the optical portion 10, and the second flange portion 32 may extend from the second edge 12 of the optical portion 10.

The first edge 11 of the optical portion 10 may be a portion adjacent to the first flange portion 31, and the second edge 12 of the optical portion 10 may be a portion adjacent to the second flange portion 32.

The third edge 13 of the optical portion 10 may be one side surface of the optical portion 10 on which the flange portion 30 is not formed, and the fourth edge 14 of the optical portion 10 may be the other side surface of the optical portion 10 on which the flange portion 30 is not formed.

A side surface of the first flange portion 31 may have a first flat surface portion 31a and first curved surface portions 31b. The first flat surface portion 31a may be a side surface that meets a virtual line extending from the major axis of the optical portion 10. The first flat surface portion 31a may be a flat surface.

The first curved surface portions 31b may be disposed on both sides of the first flat surface portion 31a, respectively. The first curved surface portion 31b may be a surface in contact with the inner surface of the lens barrel, and may be a curved surface.

The second flange portion 32 may have a second flat surface portion 32a and second curved surface portions 32b. The second flat surface portion 32a may be a side surface that meets a virtual line extending from the major axis of the optical portion 10. The second flat surface portion 32a may be a flat surface.

The second curved surface portions 32b may be disposed on both sides of the second flat surface portion 32a, respectively. The second curved surface portion 32b may be a surface in contact with the inner surface of the lens barrel, and may be a curved surface.

Meanwhile, since the plurality of lens modules divide the image capturing target and each capture an image of each section of the divided image capturing target, or each capture an image of the same image capturing target, the optical axes of the plurality of lens modules may be arranged close to each other.

Accordingly, each lens module may have an opening in each of plural surfaces facing adjacent lens modules.

For example, each lens module may have a first opening 113a and second openings 113b.

The first lens barrel 115 of the first lens module 110 may have the first opening 113a provided at a portion meeting the minor axis b of the second lens L2 and the second openings 113b provided at portions meeting the major axis a of the second lens L2.

For example, for each lens module, the first opening 113a may be provided at a portion meeting any one of both sides of a virtual line extending from the minor axis b of the second lens L2, and the second openings 113b may be provided at portions meeting both sides of a virtual line extending from the major axis a of the second lens L2.

That is, for each lens module, the first opening 113a may include one opening passing through one side surface of the first lens barrel 115, and the second openings 113b may include two openings passing through both side surfaces of the first lens barrel 115.

With such a configuration, the optical axes of the plurality of lens modules may be positioned close to each other.

Referring to FIGS. 7A through 7C, in a plane perpendicular to the optical axis, a width of the first lens barrel 115 in the first axial direction (X-axis direction) perpendicular to the optical axis (Z-axis) may be larger than a width of the first lens barrel 115 in the second axial direction (Y-axis direction) perpendicular to both the optical axis (Z-axis) and the first axial direction (X-axis direction).

The first lens barrel 115 may have a first side surface portion 116, a second side surface portion 117, a third side surface portion 118, and a fourth side surface portion 119.

When viewed in the optical axis direction (Z-axis direction), the first side surface portion 116 and the second side surface portion 117 may be disposed to face each other with respect to the optical axis (Z-axis), and the third side surface portion 118 and the fourth side surface portion 119 may be disposed to face each other with respect to the optical axis (Z-axis).

The third side surface portion 118 and the fourth side surface portion 119 may each connect the first side surface portion 116 and the second side surface portion 117.

A total distance between the first side surface portion 116 and the second side surface portion 117 may be larger than a total distance between the third side surface portion 118 and the fourth side surface portion 119.

The first side surface portion 116 and the second side surface portion 117 may each have curved surfaces provided at portions meeting the third side surface portion 118 and the fourth side surface portion 119, respectively.

For example, the first side surface portion 116 may have a first side surface 116a and second side surfaces 116b and 116c. The first side surface 116a may be a side surface that meets a virtual line extending in the first axial direction (X-axis direction) while passing the optical axis (Z-axis). The first side surface 116a may have a flat surface.

The second side surfaces 116b and 116c may be disposed on both sides of the first side surface 116a. The second side surfaces 116b and 116c may be curved surfaces.

The second side surface portion 117 may have a third side surface 117a and fourth side surfaces 117b and 117c. The third side surface 117a may be a side surface that meets a virtual line extending in the first axial direction (X-axis direction) while passing the optical axis (Z-axis). The third side surface 117a may have a flat surface.

The fourth side surfaces 117b and 117c may be disposed on both sides of the third side surface 117a. The fourth side surfaces 117b and 117c may be curved surfaces.

The third side surface portion 118 and the fourth side surface portion 119 may have flat surfaces.

The first lens barrel 115 may have flat surfaces provided at side surfaces facing other adjacent lens barrels (for example, the second lens barrel and the third lens barrel), respectively.

For example, the second side surface portion 117 and the third side surface portion 118 of the first lens barrel 115 may be surfaces facing other adjacent lens barrels (for example, the second lens barrel and the third lens barrel), and the second side surface portion 117 and the third side surface portion 118 may have flat surfaces. Here, the flat surfaces provided on the second side surface portion 117 and the third side surface portion 118 will be referred to as first flat surfaces.

In addition, the first side surface portion 116 and the fourth side surface portion 119 of the first lens barrel 115 may be surfaces that do not face other adjacent lens barrels. The first side surface portion 116 and the fourth side surface portion 119 may also have flat surfaces. Here, the flat surfaces provided in the first side surface portion 116 and the fourth side surface portion 119 will be referred to as second flat surfaces.

In this way, the side surface of the lens module may have a flat surface, such that the overall sizes of the lens assembly and the camera module may be reduced.

The first opening 113a may be provided in the third side surface portion 118 or the fourth side surface portion 119, and the second openings 113b may be provided in the first side surface portion 116 and the second side surface portion 117, respectively.

For example, the first opening 113a penetrates through the third side surface portion 118 or the fourth side surface portion 119 in the second axial direction (Y-axis direction), and the second openings 113b penetrate through the first side surface portion 116 and the second side surface portion 117, respectively, in the first axial direction (X-axis direction).

That is, in a case in which the third side surface portion 118 of the first lens barrel 115 faces a third side surface portion of another lens barrel (for example, the third lens barrel), the first opening 113a may be provided in the third side surface portion 118. Here, the respective third side surface portions of the two lens barrels may abut each other. Alternatively, the third side surface portion of one lens barrel having the first opening 113a may face or abut a fourth side surface portion of another lens barrel having an opening alike the first opening 113a.

Further, in a case in which the second side surface portion 117 of the first lens barrel 115 faces another lens barrel (for example, the second lens barrel), the second opening 113b may be provided in the second side surface portion 117.

Meanwhile, the first opening 113a may be provided only in the third side surface portion 118 (a side surface facing an adjacent lens barrel) of the first lens barrel 115, but the second opening 113b may be provided in both the second side surface portion 117 (a side surface facing another adjacent lens barrel) of the first lens barrel 115 and the first side surface portion 116 (a side surface that does not face an adjacent lens barrel) of the first lens barrel 115.

With such a configuration, the degree of freedom in arrangement of the plurality of lens modules may be increased.

A non-circular lens (for example, the second lens L2) may be accommodated in the first lens barrel 115, and the second lens L2 may be partially exposed to the outside of the first lens barrel 115 through the first opening 113a and the second opening 113b.

For example, the third edge 13 or the fourth edge 14 of the second lens L2 may be exposed to the outside of the first lens barrel 115 through the first opening 113a. In addition, the edges of each lens module exposed through the first opening 113a may be disposed to face each other.

In addition, the first flat surface portion 31a and the second flat surface portion 32a of the second lens L2 may be exposed to the outside of the first lens barrel 115 through the second openings 113b.

Meanwhile, referring to FIG. 10, a shorter side of a virtual rectangle connecting the optical axes of the respective lens modules to each other may be parallel to a shorter side of the image sensor 410, and a longer side of the virtual rectangle connecting the optical axes of the respective lens modules to each other may be parallel to a longer side of the image sensor 410.

In addition, an area of the virtual rectangle connecting the optical axes of the respective lens modules to each other may be smaller than an area of an effective image capturing region of the image sensor 410.

As set forth above, according to one or more embodiments and as a non-limiting example, a lens assembly and a camera module including the same may capture a high-resolution image or video while having a small size.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens assembly device comprising:
a lens assembly, including:
a plurality of lens modules arranged adjacently to each other, where each of the plurality of lens modules respectively accommodates one or more lenses; and
a lens holder in which the plurality of lens modules are disposed,
wherein, for each of the plurality of lens modules, a respective lens module includes:
a side surface facing another lens module, of the plurality of lens modules, that is disposed adjacent to the respective lens module, where the side surface includes at least a first flat surface; and
at least one lens, of the one or more lenses of the respective lens module, having a first total length in a first axial direction, perpendicular to an optical axis of the respective lens module, and a second total length in a second axial direction, perpendicular to both the optical axis and the first axial direction, where the first total length is longer than the second total length.

2. The device of claim 1, wherein the respective lens module of each of the plurality of lens modules further includes:
an opening penetrating through the first flat surface; and
a portion of the at least one lens being exposed to an exterior of the respective lens module through the opening.

3. The device of claim 1, wherein the respective lens module of each of the plurality of lens modules further includes:
a first side surface portion, a second side surface portion, a third side surface portion, and a fourth side surface portion;
the first side surface portion and the second side surface portion being disposed to face each other with respect to the optical axis, the third side surface portion and the fourth side surface portion being disposed to face each other with respect to the optical axis; and
a total distance between the first side surface portion and the second side surface portion being larger than a total distance between the third side surface portion and the fourth side surface portion.

4. The device of claim 3, wherein the respective lens module of each of the plurality of lens modules further includes:
the first flat surface being provided at the third side surface portion or the fourth side surface portion to face the other lens module; and
the first flat surface having an opening penetrating through the first flat surface, from an interior of the respective lens module to an exterior of the respective lens module.

5. The device of claim 3, wherein the respective lens module of each of the plurality of lens modules further includes:
the first flat surface being provided at the third side surface portion or the fourth side surface portion to face the other lens module;
the second side surface portion or the first side surface portion being disposed to face an additional lens module, of the plurality of lens modules, that is disposed adjacent to the respective lens module; and
the first side surface portion and the second side surface portion each have a second flat surface.

6. The device of claim 5, wherein the respective lens module of each of the plurality of lens modules further includes:
the first flat surface having a first opening penetrating through the first flat surface in the second axial direction, from an interior of the respective lens module to an exterior of the respective lens module, and
the second flat surface of the first side surface portion or the second side surface portion having a second opening penetrating through the second flat surface in the first axial direction, from the interior of the respective lens module to the exterior of the respective lens module.

7. The device of claim 1,
wherein the plurality of lens modules include at least a first lens module, a second lens module, a third lens module, and a fourth lens module, each further including a first surface portion and a second surface portion,
wherein an opening in the first flat surface of the first lens module faces an opening in the first flat surface of the second lens module to expose a side surface of the at least one lens of the first lens module to a side surface of the at least one lens of the second lens module, and an opening through the first flat surface of the third lens module faces an opening in the first flat surface of the fourth lens module to expose a side surface of the at least one lens of the third lens module to a side surface of the at least one lens of the fourth lens module,
wherein the first surface portion of the first lens module faces the second surface portion of the third lens module, and the second surface portion of the second lens module faces the first surface portion of the fourth lens module, and
wherein the second surface portion of the first lens module includes a first opening, the first surface portion of the second lens module includes a second opening, the first surface portion of the third lens module includes a third opening, and the second surface portion of the fourth lens module includes a fourth opening, with each of the first opening, the second opening, the third opening, and the fourth opening respectively exposing another side surface of the at least one lens of each of the first lens module, the second lens module, the third lens module, and the fourth lens module to respective exteriors of the first lens module, the second lens module, the third lens module, and the fourth lens module.

8. The device of claim 1, wherein the respective lens module of each of the plurality of lens modules further includes:
the at least one lens having an optical portion and flange portions extending from the optical portion; and
the optical portion having a first edge, a second edge, a third edge, and a fourth edge when viewed in an optical axis direction of the respective lens module, with the first edge having an arc shape, the second edge being provided on an opposite side from the first edge with respect to the optical axis and having an arc shape, and the third edge and the fourth edge respectively connecting the first edge and the second edge to each other.

9. The device of claim 8,
wherein the respective lens module of each of the plurality of lens modules further includes an opening in the first flat surface through which the third edge or the fourth edge is exposed to an exterior of the respective lens module, to expose the optical portion to the exterior, and
wherein the opening of a first lens module of the plurality of lens modules faces the opening of a second lens module of the plurality of lens modules.

10. The device of claim 8, wherein the respective lens module of each of the plurality of lens modules further includes the flange portions having a first flange portion extending from the first edge, and a second flange portion extending from the second edge.

11. The device of claim 10, wherein the respective lens module of each of the plurality of lens modules further includes:
a side surface of the first flange portion having a first flat surface portion and first curved surface portions;
a side surface of the second flange portion having a second flat surface portion and second curved surface portions;
the first flat surface portion and the second flat surface portion being surfaces meeting a virtual line passing through the optical axis and extending in the first axial direction;
the first curved surface portions being disposed on both sides of the first flat surface portion; and
the second curved surface portions being disposed on both sides of the second flat surface portion.

12. The device of claim 11, wherein the respective lens module of each of the plurality of lens modules further includes surfaces of the respective lens module, which correspond to the first flat surface portion and the second flat surface portion, having openings through which the first flat surface portion and the second flat surface portion are at least partially exposed to the exterior of the respective lens module, respectively.

13. The device of claim 1, wherein the lens holder has opening portions through which portions of respective side surfaces of each of the plurality of lens modules are exposed, and
the opening portions are respectively provided at positions, along an exterior of the lens holder, that meet respective virtual lines connecting optical axes of lens modules, of the plurality of lens modules, disposed to face each other in respective diagonal directions.

14. The device of claim 1, further comprising a single image sensor, wherein the lens assembly and single image sensor are configured as a camera module.

15. The device of claim 14, wherein a shorter side of a virtual rectangle, connecting each optical axis of the plurality of lens modules, is parallel to a shorter side of the single image sensor, and
a longer side of the virtual rectangle is parallel to a longer side of the single image sensor.

16. A lens assembly device, comprising:
a camera module, including:
a plurality of lens modules arranged adjacently to each other, where each of the plurality of lens modules respectively accommodates one or more lenses;
a lens holder accommodating the plurality of lens modules;
a housing accommodating the lens holder; and
an image sensor module coupled to the housing,
wherein, for each of the plurality of lens modules, a respective lens module includes:
four side surfaces, each of the four side surfaces having at least a flat surface;
at least one side surface of the four side surfaces having an opening penetrating through the flat surface of the at least one side surface;
at least one lens, of the one or more lenses of the respective lens module, having a first total length in a first axial direction, perpendicular to an optical axis of the respective lens module, and a second total length in a second axial direction, perpendicular to both the optical axis and the first axial direction, where the first total length is longer than the second total length; and
at least a portion of a side surface of the at least one lens being exposed to an outside of the respective lens module through the opening.

17. The device of claim 16, wherein the image sensor module includes a single image sensor configured in the camera module for receipt of light directed by each of the plurality of lens modules toward the single image sensor.

18. The device of claim 17, wherein a shorter side of a virtual rectangle, connecting each optical axis of the plurality of lens modules, is parallel to a shorter side of the single image sensor, and
a longer side of the virtual rectangle is parallel to a longer side of the single image sensor.

19. The device of claim 17, wherein an area of a virtual rectangle, connecting each optical axis of the plurality of lens modules, to each other is smaller than an area of an effective image capturing region of the single image sensor.

20. The device of claim 17, wherein, with respect to capturing an image of an entirety of an object, each of the one or more lenses of the plurality of lens modules respectively directs light from at least differently observed portions of the object toward at least separate portions of the single image sensor, or each of the one or more lenses of the plurality of lens modules respectively direct light of the entirety of the object toward at least same portions of the single image sensor.

21. A lens assembly device, comprising:
a camera module, including:
a single image sensor;
a plurality of lens modules arranged adjacently to each other, where each of the plurality of lens modules respectively accommodates one or more lenses; and
a lens holder accommodating the plurality of lens modules,
wherein the plurality of lens modules include two lens modules each having abutting side surfaces meeting a virtual line passing through optical axes of the two lens modules, with the abutting side surfaces having adjacent openings that expose respective side surfaces of optical portions of lenses, respectively of the one or more lenses, of the two lens modules to each other, and
wherein each of the lenses further include respective flanges that extend from the optical portions, where the respective flanges are disposed to face at least respective interior side surfaces of the two lens modules.

22. The device of claim 21, wherein, for each of the lenses, a respective lens includes a first total length in a first axial direction, perpendicular to an optical axis of the respective lens, and a second total length in a second axial direction, perpendicular to the optical axis and the first axial direction, where the first total length is longer than the second total length.

23. The device of claim 21, wherein the respective interior side surfaces each have a surface portion with an opening that exposes respective side surfaces of the flanges to respective exteriors of the two lens modules.

24. The device of claim 21, wherein the plurality of lens modules include another two lens modules each having other abutting side surfaces meeting a virtual line passing through optical axes of the other two lens modules, with the other abutting side surfaces having adjacent openings that expose respective side surfaces of optical portions of other lenses, respectively of the one or more lenses, of the other two lens modules to each other.

25. The device of claim 24, wherein the plurality of lens modules includes only four lens modules.

26. The device of claim 24, wherein each of the optical portions and the other optical portions has a first edge, a second edge, and a third edge when viewed in an optical axis direction of a corresponding lens module, with the first edge having an arc shape, the second edge being provided on an opposite side from the first edge with respect to the optical axis of the corresponding lens module and having an arc shape, and the third edge connecting the first edge and the second edge to each other, and
wherein the exposure of the side surfaces of the respective side surfaces of the optical portions of the lenses of the two lens modules to each other includes exposing the third edge of each of the two lens modules to each other, and the exposure of the side surfaces of the respective edges of the optical portions of the other lenses of the other two lens modules to each other includes exposing the third edge of each of the other two lens modules to each other.

27. The device of claim 24, wherein a shorter side of a virtual rectangle, connecting each optical axis of the plurality of lens modules, is parallel to a shorter side of the single image sensor, and a longer side of the virtual rectangle is parallel to a longer side of the single image sensor.

28. The device of claim 24, wherein the lens holder has opening portions through which portions of respective side surfaces of each of the plurality of lens modules are exposed, and
the opening portions are respectively provided at positions, along an exterior of the lens holder, that meet respective virtual lines connecting optical axes of lens modules, of the plurality of lens modules, that are disposed to face each other in respective diagonal directions.

29. The device of claim 21, wherein the plurality of lens modules and the lens holder are included in a lens assembly, and wherein the camera module is configured to move the lens assembly in a direction parallel to the optical axes and relative to the single image sensor and/or move the lens assembly in one or more directions perpendicular to the optical axes and relative to the single image sensor, for respectively performing focus adjustments and/or image stabilization.
